(19) United States
(12) Patent Application Publication
(10) Pub. No.: US 2016/0320213 A1
(43) Pub. Date: Nov. 3, 2016

(54) FLICK SENSOR ASSEMBLY

(71) Applicant: SHENZHEN CHINA OPTOELECTRONICS TECHNOLOGY CO., LTD, Shenzhen, Guangdong (CN)

(72) Inventor: Jia LI, Shenzhen, Guangdong (CN)

(21) Appl. No.: 14/647,102

(22) PCT Filed: Apr. 10, 2014
(86) PCT No.: PCT/CN2014/075118

§ 371 Date: May 25, 2015

(30) Foreign Application Priority Data
Jan. 24, 2014 (CN) 201410037657.5

(51) Int. Cl. G01D 5/44; F16K 31/06

(52) U.S. Cl. CPC G01D 5/44; F16K 31/06

(57) ABSTRACT

The present invention discloses a flick sensor assembly. The flick sensor assembly comprises a bracket, a vibrating component and a liquid injecting device, wherein the vibrating component is pivotally mounted on the bracket; the liquid injecting device is configured to inject liquid onto the vibrating component. By injecting the liquid onto the vibrating component, the liquid from the liquid injecting device will wash and push the vibrating component of the flick sensor, such that the vibrating component of the flick sensor is not adhered and has enough restoring force. In this way, the vibrating component of the flick sensor is sensitive to the glass substrate, the detected signals can be transmitted, the downtime and maintenance time of the equipment can be reduced, and the yield rate of the product and the utilization rate of the equipment can be improved.

### FIELD OF THE INVENTION

The present invention pertains to the liquid crystal display manufacturing field. In particular, the present invention relates to a flick sensor assembly.

### BACKGROUND OF THE INVENTION

In the process of manufacturing liquid crystal panel, the glass substrate for manufacturing liquid crystal panel will pass through one or more liquid chambers in the wet process, in the liquid chamber strong acid or alkali solution is filled. The moving information of the glass substrate passing through the liquid chamber in the wet process is detected and informed to the next process by a flick sensor, namely when the glass substrate passes through the liquid chamber, the glass substrate contacts and pushes the vibrating component of the flick sensor, such that the vibrating component of the flick sensor is tilted to an angle, and when the glass substrate is apart from the vibrating component of the flick sensor, the vibrating component of the flick sensor return to the home position and a signal is transmitted to the next process such that the next process is prepared to take over the glass substrate. However, the flick sensor works in liquid environment, if the vibrating component of the flick sensor is not active for a long period, then the liquid will be dried, such that the vibrating component of the flick sensor is adhered and/or the restoring force of the vibrating component drops. In such cases, when the glass substrate pass through the liquid chamber, the vibrating component of the flick sensor cannot be bent and return to the home position, and the signal will not be transmitted to the next process. When the next process cannot receive the signal, the glass substrate will be soaked in strong acid or alkali solution, causing the scrapping of the products, thus reducing the yield rate of the product. Moreover, once the flick sensor failed to transmit signals, it is necessary to turn off the equipment for maintenance; the equipment utilization rate is reduced.

### SUMMARY OF THE INVENTION

The present invention provides a flick sensor assembly, which can ensure that the vibrating component of the flick sensor is not adhered and has enough restoring force.

The present invention is realized in such a way that: A flick sensor assembly, the flick sensor assembly comprising a bracket, a vibrating component and a liquid injecting device, the vibrating component is pivotally mounted on the bracket, the liquid injecting device is configured to inject liquid onto the vibrating component.

Preferably, the liquid injecting device is a water injecting device.

Preferably, the bracket comprises a pin, the vibrating component is connected with the pin in such a manner that the vibrating component rotates around the pin.

Preferably, the liquid injecting device comprises a liquid storage tank, a liquid pipeline and a control valve, the control valve is arranged on the liquid pipeline.

Preferably, the control valve is an electromagnetic control valve.

Preferably, the flick sensor assembly further comprises a control unit; the control unit is electrically connected with the control valve.

Preferably, the liquid pipeline is made of perfluoroalkoxy alkane.

Preferably, the inner diameter of the liquid pipeline is 4 mm˜10 mm.

Preferably, the distance between the outlet of the liquid pipeline and the vibrating component is 10 mm˜60 mm.

Preferably, the distance between the outlet of the liquid pipeline and the vibrating component is 30 mm.

Compared with the prior art, the present invention has the following advantages. Even the flick sensor is inactive for a long period and the liquid in the chambers is dried, such that the vibrating component of the flick sensor is adhered and/or the restoring force of the vibrating component drops, by injecting the liquid onto the vibrating component, the liquid from the liquid injecting device will wash and push the vibrating component of the flick sensor, such that the vibrating component of the flick sensor is not adhered and has enough restoring force. In this way, the vibrating component of the flick sensor is sensitive to the glass substrate, the detected signals can be transmitted, the downtime and maintenance time of the equipment can be reduced, and the yield rate of the product and the utilization rate of the equipment can be improved.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 shows that the vibrating component of the flick sensor assembly tilts normally when the glass substrate passes through according to an embodiment of the present invention;

FIG. 2 shows that a vibrating component in prior art cannot tilt normally and return to home position when the glass substrate passes through; and

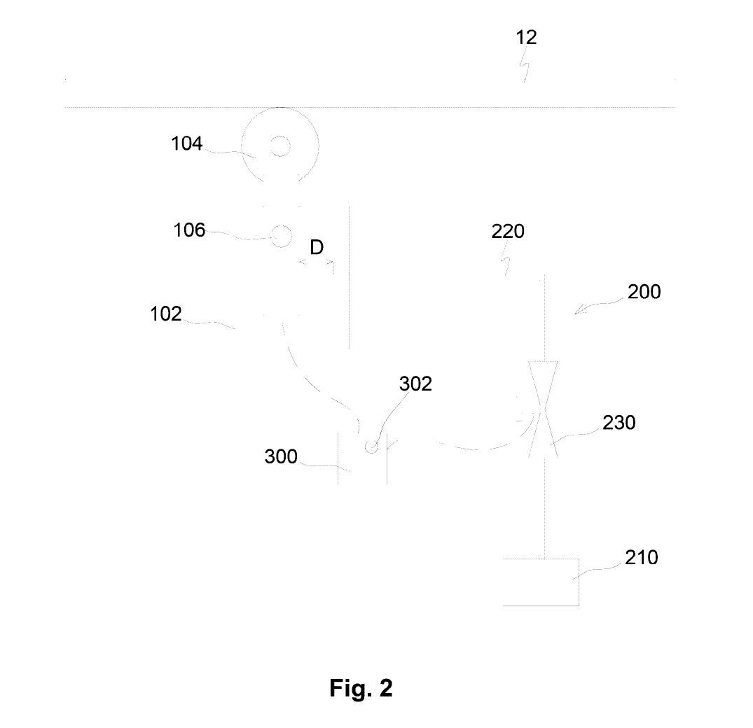

FIG. 3 shows the connection relationship between the bracket and the vibrating component of the flick sensor assembly according to the embodiment in FIG. 1.

### DETAILED DESCRIPTION OF THE PREFERRED EMBODIMENTS

The embodiments of the present invention will be described in detail with reference to the accompanying drawings.

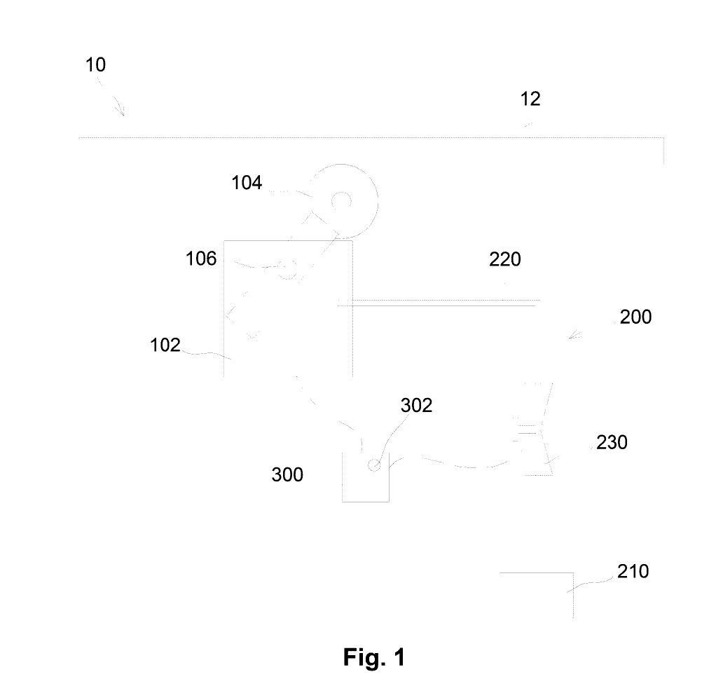

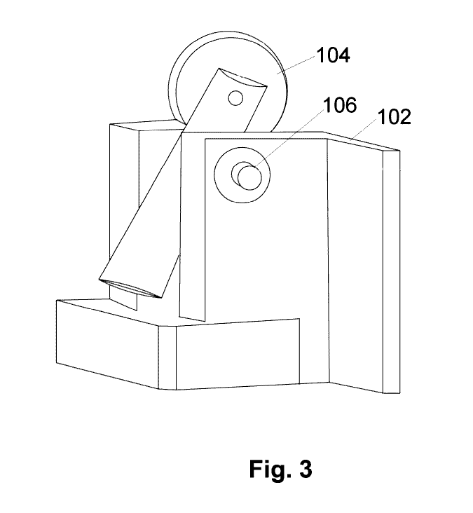

As shown in FIG. 1, the flick sensor assembly 10 in the present embodiment comprises a bracket 102, a vibrating component 104, a control unit 300 and a liquid injecting device 200. The vibrating component 104 is pivotally mounted on the bracket 102. The liquid injecting device 200 is configured to inject liquid onto the vibrating component 104. As shown in FIG. 3, the bracket 102 comprises a pin 106, the vibrating component 104 is connected with the pin 106 in such a manner that the vibrating component 104 can rotate around the pin 106.

In the present embodiment, the liquid injecting device 200 is a water injecting device. And the liquid injecting device 200 comprises a liquid storage tank 210, a liquid pipeline 220 and a control valve 230, the control valve 230 is arranged on the liquid pipeline 220. Preferably, the control valve 230 is an electromagnetic control valve. The control unit 300 is electrically connected with the control valve 230.

Preferably, the control unit 300 comprises a touch panel. On the touch panel of the control unit 300, there is provided with a soft button 302 for opening or closing the control valve 230. When it is necessary to inject liquid onto the vibrating component 104, the control valve 230 can be opened by clicking on the soft button 302. When it is not necessary to inject liquid onto the vibrating component 104, the control valve 230 can be closed by clicking on the soft button 302 once again. By this way, the remote control of the control valve 230 can be realized.

The liquid pipeline 220 is made of perfluoroalkoxy alkane.The inner diameter of the liquid pipeline 220 is 4 mm˜10 mm. The inner diameter of the liquid pipeline 220 is preferably 5 mm. The liquid pipeline 220 made of perfluoroalkoxy alkane is resistant to strong acid and strong alkali solution. And the liquid pipeline 220 can be secured to make sure that the outlet of the liquid pipeline 220 faces the vibrating component 104. In the present embodiment, the outlet of the liquid pipeline 220 is mounted on the bracket 102. As shown in FIG. 3, the distance D between the outlet of the liquid pipeline 220 and the vibrating component 104 is 10 mm˜60 mm. When the distance D between the outlet of the liquid pipeline 220 and the vibrating component 104 is 10 mm˜60 mm, the liquid from the outlet of the liquid pipeline 220 can reach the vibrating component 104. Preferably, the distance D between the outlet of the liquid pipeline 220 and the vibrating component 104 is 30 mm. Based on experiments, when the distance D between the outlet of the liquid pipeline 220 and the vibrating component 104 is about 30 mm, the liquid can push the vibrating component 104 to move and return to the home position quickly.

According to the flick sensor assembly in the present embodiment, by injecting the liquid onto the vibrating component 104, the liquid from the liquid injecting device 200 will wash and push the vibrating component 104 of the flick sensor, such that oxalate crystals on the vibrating component of the flick sensor can be dissolved, the vibrating component of the flick sensor is not adhered and has enough restoring force. It can be avoided that the liquid chambers are opened to adjust the vibrating component of the flick sensor manually. Also the maintenance time can be reduced.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A flick sensor assembly, comprising a bracket, a vibrating component and a liquid injecting device, wherein the vibrating component is pivotally mounted on the bracket, the liquid injecting device is configured to inject liquid onto the vibrating component.

2. The flick sensor assembly of claim 1, wherein the liquid injecting device is a water injecting device.

3. The flick sensor assembly of claim 1, wherein the bracket comprises a pin, the vibrating component is connected with the pin in such a manner that the vibrating component rotates around the pin.

4. The flick sensor assembly of claim 1, wherein the liquid injecting device comprises a liquid storage tank, a liquid pipeline and a control valve, the control valve is arranged on the liquid pipeline.

5. The flick sensor assembly of claim 4, wherein the control valve is an electromagnetic control valve.

6. The flick sensor assembly of claim 5, wherein the flick sensor assembly further comprises a control unit; the control unit is electrically connected with the control valve.

7. The flick sensor assembly of claim 4, wherein the liquid pipeline is made of perfluoroalkoxy alkane.

8. The flick sensor assembly of claim 4, wherein the inner diameter of the liquid pipeline is 4 mm˜10 mm.

9. The flick sensor assembly of claim 4, wherein the distance between the outlet of the liquid pipeline and the vibrating component is 10 mm˜60 mm.

10. The flick sensor assembly of claim 4, wherein the distance between the outlet of the liquid pipeline and the vibrating component is 30 mm.
